(19) United States
(12) Patent Application Publication
(10) Pub. No.: US 2003/0058938 A1
(43) Pub. Date: Mar. 27, 2003

(54) Process for coding according to the MPEG standard

(76) Inventors: Edouard Francois, Bourg des Comptes (FR); Philippe Bordes, Laille (FR); Dominique Thoreau, Cesson Sevigne (FR)

Correspondence Address: JOSEPH S. TRIPOLI, THOMSON MULTIMEDIA LICENSING, INC., 2 INDEPENDENCE WAY, P.O. BOX 5312, PRINCETON, NJ, 08543-5312, US

(21) Appl. No.: 10/247,050

(22) Filed: Sep. 19, 2002

(30) Foreign Application Priority Data
Sep. 24, 2001 (FR) 0112251

(51) Int. Cl. H04N 7/12

(52) U.S. Cl. 375/240.08

(57) ABSTRACT

The process is characterized in that it calculates the predicted position of the current macroblock to be coded in the next image or vop, by considering the order of display of the images, and in that a coding parameter for the macroblock depends on whether or not the predicted macroblock lies outside the next image or vop.

### FIELD OF THE INVENTION

The invention relates to a process of coding and of decoding with temporal prediction.

### BACKGROUND OF THE INVENTION

The standards involved are for example H261, H263, MPEG, generally the standards based on blockwise image coding and on motion compensation.

Such standards describe the chopping of an image into windows of 16×16 pixels called macroblocks. The content of the image is encoded macroblock by macroblock. When temporal prediction is utilized for the coding, a macroblock may be predicted on the basis of a past or future image, when considering the order of display rather than the order of coding of the images, with the aid of one or more motion vectors per macroblock.

The remainder of the document will speak either of image or of VOP (Video Object Plane). This is a concept introduced by the MPEG4 standard which defines a video object plane, that is to say the photograph of a video object at a given instant. A VOP is a rectangular image, whose size may vary over time, consisting of a form, for example a binary mask, and of a texture. The principles described hereinbelow relate equally well to the rectangular conventional images of the MPEG2 standard and to the VOPs of the MPEG4 standard.

The transmission of data streams over heterogeneous networks or over the Internet frequently generates transmission errors. The decoder is then faced with the reconstruction of missing pieces of images. Most of the digital recording media and communication channels are not protected against errors.

The MPEG standard supports modes which are robust to errors.

Among the existing tools for limiting the problems due to transmission errors, a first means called resynchronization consists in inserting resynchronization markers into the stream, defining video packets.

A second level of protection making it possible to mask errors (referred to as error concealment in the standard) consists of a partitioning of the data in the video packets relating to the I and P images. The headers of the macroblocks are placed at the start of the video packet and the texture macroblocks are placed thereafter, separated by a marker inside the video packet. If the texture data are lost, the images may be reconstructed from the motion information.

Another level of protection allowing the recovery of the data consists in utilizing a reversible variable-length code RVLC for the texture data. A transmission error detected in the stream thus makes it possible to take up position on the synchronization word of the next video packet and to perform backward decoding.

Another means relates to the modes of coding the macroblocks. A refreshing of macroblocks in intra mode, that is to say a forcing of the mode of coding of a macroblock to intra mode is performed periodically to limit the propagations of errors due to the inter coding. However, such coding in intra mode is expensive in terms of coding bits.

The aim of the invention is to limit the aforesaid drawbacks.

### SUMMARY OF THE INVENTION

Accordingly, the subject of the invention is a process for coding according to the MPEG standard, characterized in that it calculates the predicted position of the current macroblock to be coded in the next image or vop, by considering the order of display of the images, and in that a coding parameter for the macroblock depends on whether or not the predicted macroblock lies outside the next image or vop.

According to a particular implementation of the invention, the coding parameter is the intra or inter mode of coding or quantization interval for the TCD coefficients of the macroblock.

According to another particular implementation of the invention, the coding parameter also takes into account the number of B images or B-vops situated between the image or current P vop and the image or next P vop.

According to a variant of the invention, the error masking algorithm, for a macroblock, based on a random refreshing of the macroblocks by intra coding of these macroblocks, takes into account the predicted position of this macroblock in the next image or vop.

According to another variant of the invention, the positioning of resynchronization markers corresponding in the MPEG4 standard to the start of the video packets, takes into account the predicted position of the macroblock, it also being possible to modify the size of the packets as a function of the number of macroblocks which they enclose having a position predicted outside the image.

According to another variant of the invention, during a coding utilizing the extensions to scalability to improve the accuracy of coding, this improvement is reduced or removed for the macroblocks whose predicted position lies outside the next image.

The invention proposes, for each macroblock MB, the adapting of the coding parameters for this macroblock as a function of its position predicted at the next instant. The idea is to limit the cost of coding this macroblock if there is a high probability of this macroblock lying outside the vop or the image at the next instant. It involves for example not performing the forcing to intra mode during the refreshing of a macroblock in intra mode, if this macroblock might disappear from the scene, that is to say vanish from the image for a next image.

The main advantage of the invention is to limit the costs of coding an image sequence.

### BRIEF DESCRIPTION OF THE DRAWINGS

Other features and advantages of the invention will appear clearly in the following description given by way of non-limiting example and with regard to the appended figures which represent:

FIG. 1, a current macroblock in an image whose predicted macroblock lies inside the image,

FIG. 2, a current macroblock in an image whose predicted macroblock lies outside the image,

FIG. 3, an algorithm implementing the process according to the invention.

### DETAILED DESCRIPTION OF PREFERRED EMBODIMENTS

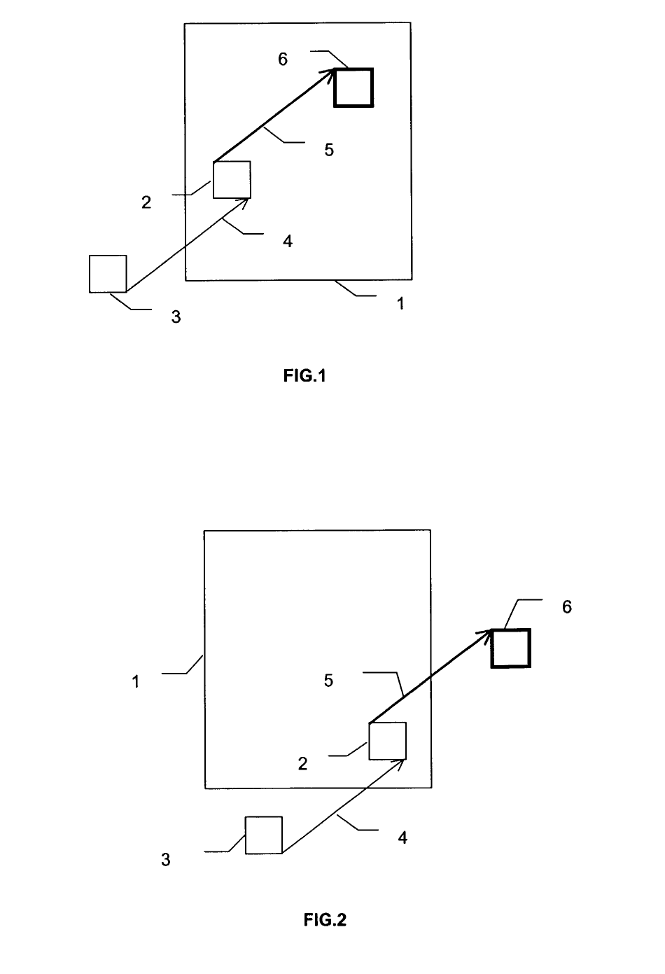

FIG. 1 represents an image or vop 1 and a current macroblock 2 inside the image. With this macroblock is associated a motion vector 4 which makes it possible to define a predicted macroblock 3 in the previous (according to the order of coding) reconstructed image, this image not being represented in the figure. The motion vector 4 which corresponds to the estimated motion of the current macroblock 2 is utilized to predict the position of this current macroblock in the next image. It is thus assumed that the motion continues from one image to another. The displacement corresponding to the motion vector 4 is thus applied to the current macroblock 2 to yield a new position, referenced 6 in the figure, of the macroblock. This is the predicted position of the current macroblock or predicted macroblock for the next image

Two cases may arise:

Either the predicted macroblock lies wholly or partly in the image. Such is the case in FIG. 1. In this case, no coding restriction is imposed on the current macroblock. The coder decides the mode of coding of the macroblock. There is no constraint related to the analysis of the position of the predicted macroblock. The macroblock can be coded in intra mode for an intra refresh as indicated previously.

Or the predicted macroblock lies completely outside the image. Such is the case in FIG. 2 where the predicted macroblock 6 is outside the image 1.

In this latter case, the mode of coding of the current macroblock 2 is modified in one or other (or more) of the following ways:

the mode of coding as forced intra, that is to say by refreshing, is prohibited. The intra coding is always possible in the case where the intra coding of the macroblock is less expensive than the inter mode of coding.

in the case where the coding implements an algorithm for the periodic refreshing of the macroblocks by intra coding, this procedure is reinitialized for the current macroblock.

In order to share out the cost of coding an image generated by an intra refresh, the macroblocks are not forced simultaneously to intra but in turn. The refresh is done macroblock by macroblock. In general, counters assigned to each macroblock of the image and carrying out a looped count are initialized in a random manner, for example when coding the first image of the sequence or GOP (Group of Pictures) in intra mode, so as to share out this coding cost. The loop counting is achieved over a number N corresponding for example to the number of images constituting a GOP, the counter is incremented at each coding and the refresh takes place while passing from N to zero. Within the framework of the invention, the counter is reinitialized when the forced intra mode of coding is prohibited. Thus, the algorithm, by repositioning the counter to zero, prohibits the refreshing of the macroblock corresponding to the position of the current macroblock, for the subsequent images. The refresh will be done only after N new codings for this position of the macroblock.

the quantization interval for the coding of the coefficients of the macroblock is forced to a high value or to a value greater than that calculated so as to reduce the cost of coding the macroblock which is presumed to disappear during the next images. This forcing may depend on the type of transmission, a low bit rate transmission permitting a reduced quality of decoding and hence a larger tolerance on the effects of blocks generated by quantization intervals which are too different from one macroblock to a neighbouring macroblock. The value of the quantization interval may also take into account the number of images of B type flanked by the current image and the next image of P type, the coding of the macroblocks of an image of B type making reference to the macroblocks of an image of P type.

in the case of coding utilizing the extensions to scalability, for example of SNR type (signal to noise ratio) such as fgs (fine granularity scalability), the coding consisting of a lower layer of coding of the DCT coefficients and one or more improvement layers, for refining the DCT coefficients, the procedure for coding these coefficients for the improvement layers is modified by reducing the number of coding bits, for example by allocating fewer bit planes than scheduled.

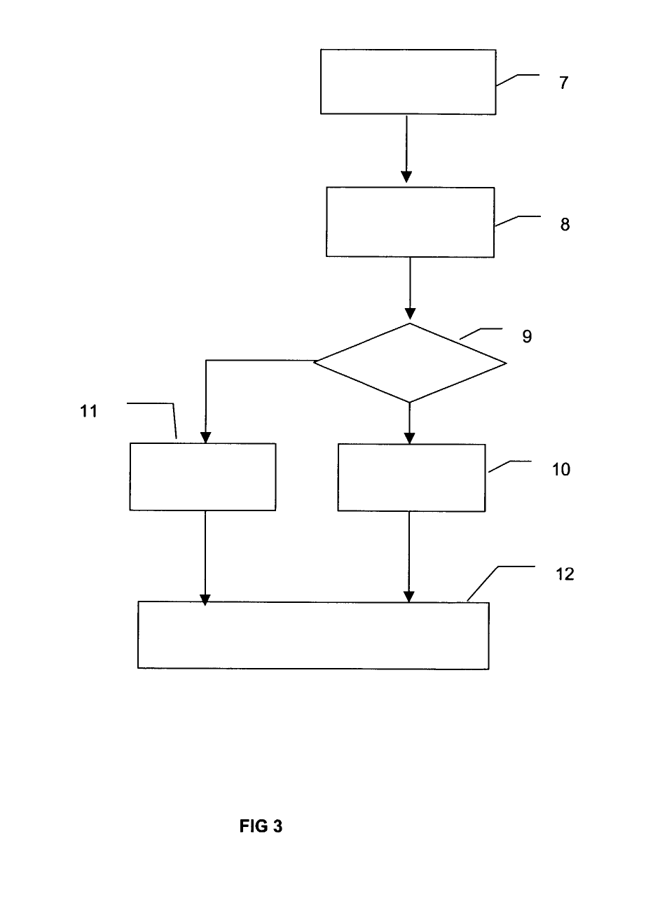

FIG. 3 represents an algorithm implementing the process according to the invention.

A first step 7 consists of a calculation of the motion vectors for a current macroblock.

The next step 8 calculates the position of this current macroblock for the next image, by extrapolating the displacement of the macroblock on the basis of the motion vector assigned to it. The next step 9 determines whether the position of the macroblock is inside or outside the image.

In the case where the predicted position of the macroblock lies at least partly inside the image, the next step is step 10 which determines the parameters for coding the macroblock in a conventional manner.

In the case where the predicted position of the macroblock lies wholly outside the image, the next step is step 11 which forces coding parameters as indicated previously. For example, the intra mode of coding is prohibited.

The next step, which is step 12, performs the coding of the macroblock as a function of the coding parameters determined in the previous step.

The algorithm proposed can take the form of an extra block added to an encoder to carry out the supplementary steps 8, 9 and 11, so as to improve the distribution of bits among the various macroblocks of an image or a VOP. Moreover, the process can be used in deciding the intra coding mode for the P-VOPs in the context of robustness to errors.

The prediction of the macroblock is performed on the basis of a motion estimate. The latter may correspond to a simple copy of the motion vector assigned to the current macroblock and therefore carrying out an extrapolation of this motion. The motion may also be estimated in a more complex manner, for example on the basis of modelling the motion field.

The MPEG 4 standard defines resynchronization markers in the MPEG data stream, the data between two markers corresponding to a video packet. A variant of the invention consists in taking account of the predicted position of the macroblocks in respect of the choice of position of the marker in the data stream. Thus, it may be decided not to place any resynchronization marker before a macroblock which ought to vanish from the image or too closely preceding such a macroblock. It is in fact rather inefficient to resynchronize the data stream with regard to forthcoming data of low importance. The data relating to a vanishing macroblock will not actually be used subsequently to predict and reconstruct macroblocks. This positioning may also take into account the density, in the stream, of the macroblocks which are to vanish from the image or depend on the gap, in the stream, between a marker and such a macroblock.

Likewise, the size of a packet situated between two resynchronization markers can be calculated as a function of the number of macroblocks which are to vanish from the image, which it encloses. The size may be larger for packets containing many macroblocks scheduled to vanish from the image and may be reduced in the converse case. The loss of information is in fact less of an impediment in respect of macroblocks which are to vanish from the image and the resynchronization can consequently be spaced further apart in respect of packets containing such macroblocks.

The codings of MPEG type utilize various types of scalability such as spatial scalability to improve the accuracy of coding. The fgs coding (fine granularity scalability) for example utilizes several levels of resolution for the coding of the macroblocks. A variant of the invention consists in making this coding accuracy relating to the improvement of accuracy depend on the status of the macroblock, that is to say on whether or not the macroblock has a predicted position outside the image. It is thus possible to reduce the number of layers or to code the dct coefficients for these improvement layers more coarsely, in respect of the macroblocks whose predicted position is outside the image or the vop.

1. Process for coding according to the MPEG standard, characterized in that it calculates the predicted position of the current macroblock to be coded in the next image or vop, by considering the order of display of the images, and in that a coding parameter for the macroblock depends on whether or not the predicted macroblock lies outside the next image or vop.

2. Process according to claim 1, characterized in that the coding parameter is the intra or inter mode of coding.

3. Process according to claim 1, characterized in that the coding parameter is the quantization interval for the TCD coefficients of the macroblock.

4. Process according to claim 2 or 3, characterized in that the coding parameter also takes into account the number of B images or B-vops situated between the image or current P vop and the image or next P vop.

5. Process according to claim 1, characterized in that the error masking algorithm, for a macroblock, based on a random refreshing of the macroblocks by intra coding of these macroblocks, takes into account the predicted position of this macroblock in the next image or vop.

6. Process according to claim 1, characterized in that the positioning of resynchronization markers defining the start of the video packets coding the images, in the MPG4 standard, takes into account the predicted position of a macroblock.

7. Process according to claim 1, characterized in that the size of the video packets coding the images and defined by the position of resynchronization markers, in the MPG4 standard, takes into account the number of macroblocks which they enclose having a predicted position outside the image.

8. Process according to claim 1, characterized in that during a coding utilizing the extensions to scalability corresponding to one or several supplementary coding layers, to improve the accuracy of coding, this layer is removed or the number of layers is reduced for the macroblocks whose predicted position lies outside the next image.
